(19) United States
(12) Patent Application Publication
(10) Pub. No.: US 2005/0204635 A1
(43) Pub. Date: Sep. 22, 2005

(54) Frame for doors with hinged leaves

(75) Inventor: Alberto Lualdi, Marcallo Con Casone (IT)

Correspondence Address: NIXON & VANDERHYE, PC, 901 NORTH GLEBE ROAD, 11TH FLOOR, ARLINGTON, VA, 22203, US

(73) Assignee: LUALDI S.p.A., Mesero (IT)

(21) Appl. No.: 10/902,488

(22) Filed: Jul. 30, 2004

(30) Foreign Application Priority Data
Mar. 16, 2004 (IT) MI2004A000488

(51) Int. Cl. E06B 1/04

(52) U.S. Cl. 49/504

(57) ABSTRACT

Frame for doors (1; 101; 201) having one or more hinged leaves (4; 204), of the type comprising at least two jambs (5a, 5b; 205a, 205b) that define a lying plane for said one or more leaves when these are in their closed position, and means (7a, 7b; 107a, 107b, 111a, 111b, 112a, 112b; 207a, 207b, 211a, 211b, 212a, 212b) for wall fixing said at least two jambs on opposite sides with respect to an access opening (2), produced in the wall (3a, 3b) of a building, or other dwelling space. The jambs and relative fixing means are structured to maintain the aforesaid lying plane parallel on the outside of an entry/exit section of the access opening.

The present invention relates to a door frame for wall mounting of a door provided with at least one hinged leaf, of the type comprising two jambs disposed in correspondence to an access opening made in a wall of a building, or other dwelling space.

Traditionally, doors with hinged leaves are mounted, in correspondence to an access opening in the wall of a building, by interposing a subframe between the opposite surfaces of the access opening and the door frame, so that said subframe reduces the size of the opening gap and consequently allows correct “flush” assembly of the frame of the door with hinged leaf, which is chosen with dimensions relatively smaller than those of the access opening.

In particular, the lateral jambs of the door frame are connected directly to the subframe, to define, inside the access opening, a lying plane for the hinged leaf, when the latter is disposed in such a way as to close said opening. The distance, orthogonal to the opposite surfaces of the access opening, between the jambs of the frame is obviously equivalent to the distance of the hinged leaf.

The need to mount a subframe interposed between the inside surfaces of the access opening and the door frame, to allow the leaf of the door to close said opening without leaving any chinks, is a complex operation which requires correct installation of the subframe and precise prior dimensioning thereof.

In order to simplify mounting a hinged leaf door of the type indicated above, the German patent application DE-A1-42.37.820 teaches how to produce the lateral jambs of the hinged leaf shaped to have an “L-shaped” profile, so that a first side thereof can be connected to an outside lateral surface of the access opening, and the other side can support the hinges of the hinged leaf. In particular, the first side of the “L-shaped” jamb can be fixed in an adjustable way to the outside lateral surface of the access opening in order to leave a possible clearance, if necessary, between the other side and the corresponding inside surface of the opening, to reduce the opening gap thereof.

In this way, it is possible to dispose, inside the access opening, a hinged leaf of predefined dimensions adjusting its position inside the opening, that is, adjusting the opening gap thereof, simply by moving one or both of the “L-shaped” jambs.

Although eliminating the need to provide a subframe, this solution is nonetheless limited to applications wherein the clearance to be defined between the inside surfaces of the opening and the hinge of the hinged leaf is of reduced size and can thereby be obtained by moving the side of the jamb, necessarily limited to the dimensions of said side, on the outside lateral surface of said opening.

Moreover, in the case in which a certain clearance is required in the space between the side of the jamb supporting the hinge of the leaf and the inside surface of the opening, it is advisable to place a tie-rod or strut that prevents any undue bending of the same side of the “L-shaped” jamb that supports the hinges of the leaf.

Finally, from the viewpoint of hygiene and aesthetics, the presence of a clearance between the side of the jamb supporting the hinge of the leaf and at least one of the two inside surfaces of the access opening entails the use of a covering that conceals the space defined by said clearance from the view of passers-by and protects it from dust.

It is therefore an object of the present invention to produce a frame for doors having one or more hinged leaves which solves the aforesaid problems of prior art and which therefore may be easily mounted in correspondence to an access opening made in a wall of a building, or other dwelling space, without requiring the installation of a subframe.

Another object of the present invention is to provide a frame for doors with hinged leaves that allows the door to be mounted essentially irrespective of the distance between the opposite surfaces of the access opening.

A further object of the present invention is to provided a method to mount a door with hinged leaves that is simple and inexpensive to carry out.

Yet another object of the present invention is to provide a door with hinged leaves that is simple to produce and easily mounted in the wall.

These and other objects are obtained by a frame for doors provided with one or more hinged leaves as claimed in the first independent claim and the subsequent dependent claims 2 to 13, by the method of mounting a door with hinged leaves as claimed in the independent claim 14 and the subsequent dependent claims 15 to 18 and by the door as claimed in claims 19 and 20.

According to the present invention, the frame for doors with one or more hinged leaves, comprises at least two jambs which define a lying plane for said one or more door leaves, when these are in their closed position, and means to fix the jambs to the wall on opposed sides with respect to an access opening provided in the wall of a building, or other dwelling space. The lateral jambs and the means to fix them are structured so that said lying plane remains parallel on the outside of an entry/exit section of the access opening.

In this way, the hinged leaf or leaves of the door extend on the outside of the access opening and the door may therefore be mounted without paying attention to the distance between the opposite surfaces of said opening, provided that said leaf or leaves have a span that is sufficient to close one of the entry/exit sections of the access opening.

This allows the door to be mounted even in the presence of extremely high working tolerances for the frame and for the dimensions of the leaves.

Moreover, according to a particularly advantageous aspect of the present invention, the aforesaid wall fixing means are structured to connect the jambs to the relative walls of the building, or other dwelling space, according to surfaces parallel to the aforesaid lying plane. In particular, said wall fixing means may comprises one or more cylindrical threaded fastening elements, such as screws or bolts.

This means that the jambs can be fixed directly to the outside surfaces of the access opening adjusting the relative distance as a function of the dimensions of the leaf or leaves, irrespective of the dimensions of the access opening.

According to another aspect of the present invention, the means for wall fixing of the two jambs comprise at least a secondary frame, that can be connected directly to a relative wall in correspondence to the access opening, and provided with fastening means for the two jambs. Preferably, these are reversible fastening means, for example of the bayonet type.

Therefore, fixing of the secondary frame to the outside lateral walls of the access opening allows the jambs of the door to be easily mounted and removed, and therefore any jamb and door having the desired aesthetic characteristics can be installed on the secondary frame, fixed to the walls. That is, the use of a secondary frame allows subsequent mounting of jambs customized according to the requirements of the user, without it being necessary to modify the wall installation (fixing) each time the type or aesthetic appearance of the jambs varies.

A further aspect of the present invention relates to a method to mount a door, of the type with one or more hinged leaves, in correspondence to an access opening made in the wall of a building, or other dwelling space, through the use of a frame provided with two or more jambs that define a lying plane for the aforesaid leaves when they are disposed to close the access opening. According to the method, the lying plane is disposed on the outside of the access opening, parallel to one of the entry sections thereof. Preferably, the two jambs can also be disposed and fixed to the sides of the access opening.

Some embodiments of the frame according to the present invention, and of the relative mounting method, shall now be described, purely as a non-limiting example, with reference to the accompanying figures, wherein:

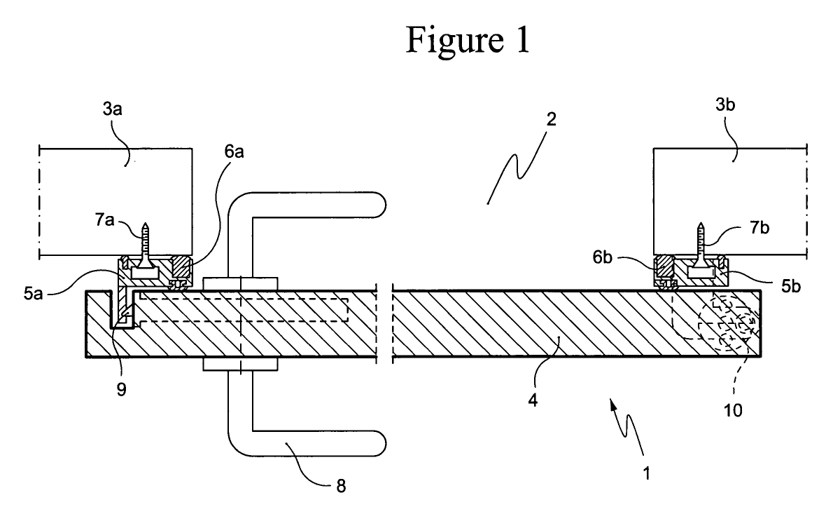

FIG. 1 shows a top sectional view of a door according to a particular aspect of the present invention;

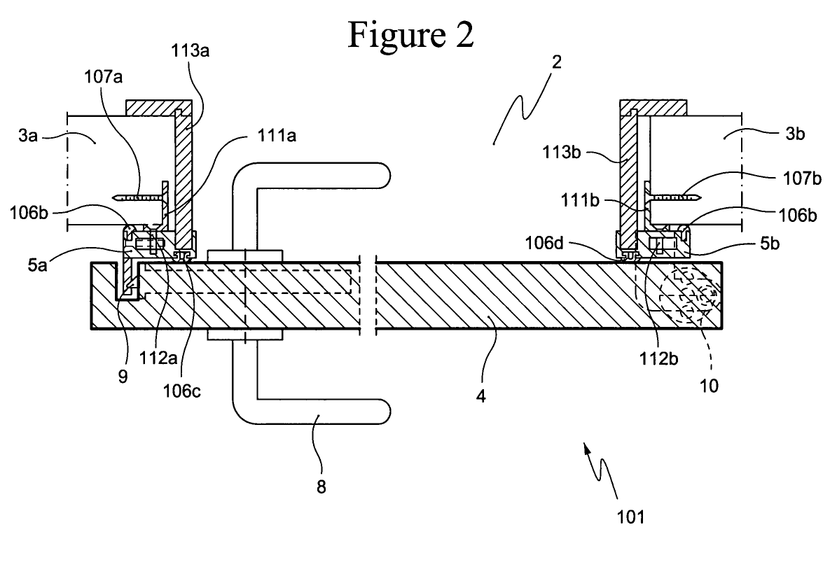

FIG. 2 shows a top sectional view of another door according to a different aspect of the present invention;

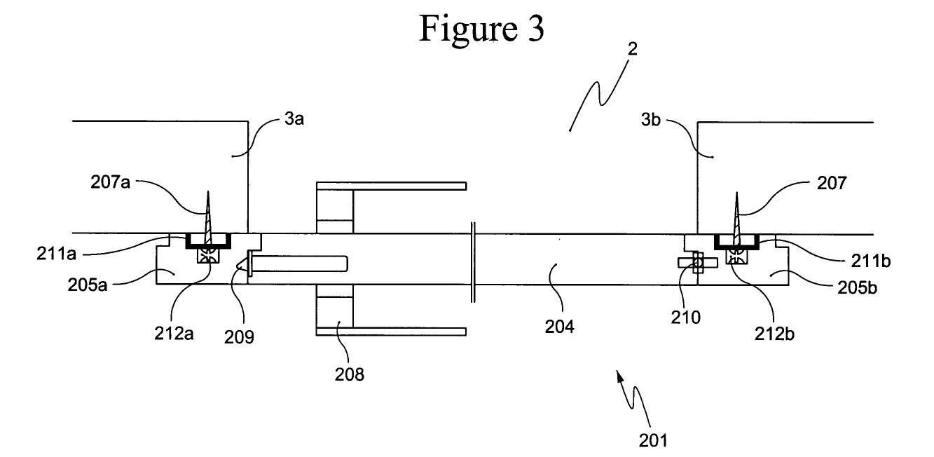

FIG. 3 shows a top sectional view of a further embodiment of the present invention;

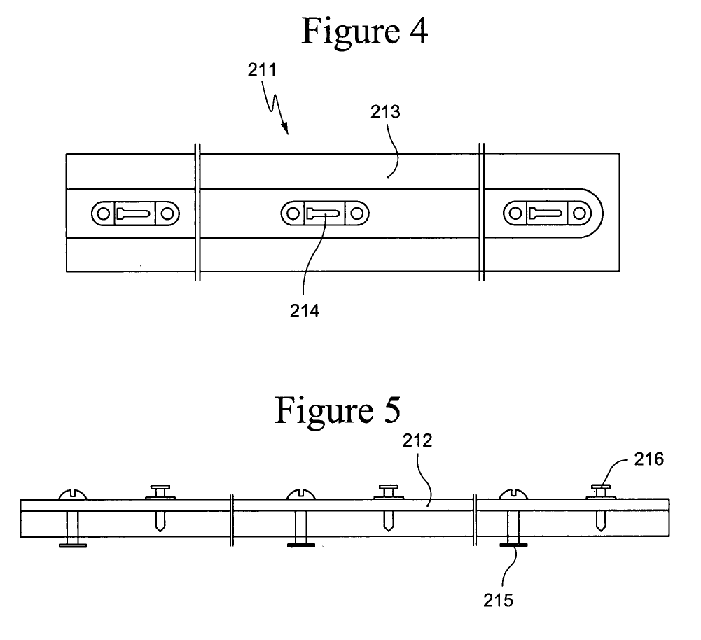

FIG. 4 shows a plan view of a fastening plate for the jambs of a door according to a preferred aspect of the present invention; and

FIG. 5 shows a plan view of an element to removably connect a jamb to the fastening plate in FIG. 4.

With reference to FIG. 1, this shows a door 1 designed to close or to allow passage through an access opening 2 produced in a wall 3a, 3b of a building, or other dwelling spaces, such as those found in a ship or in a camper.

The door 1, according to prior art, is of the type comprising a frame, mounted on which is a hinged leaf extending, when disposed in the closed position, along a lying plane defined by two lateral jambs 5a, 5b positioned on opposite sides with respect to the access opening 2. Each of the lateral jambs 5a, 5b, preferably made of aluminium, is connected to the relative wall 3a, 3b thanks to wall fixing means 7a, 7b, normally constituted by threaded fastening elements, such as screws, bolts or grub screws. The jambs 5a, 5b, in this case, have through holes (not shown) to engage said threaded elements 7a, 7b. Moreover, shims (or spacers) 6a, 6b made of synthetic material, can be disposed between the jambs 5a, 5b and the relative walls 3a, 3b.

The aforesaid lying plane of the leaf 4, in more detail, extends between the hinges 10 that connect said leaf 4 to one of the jambs 5b and the opposite doorpost, constituted by a shaped surface of the other jamb 5a, on which the lock 9 of the door 1 is disposed. The leaf 4 is completed by a handle 8 to operate the lock 9.

Advantageously, according to the present invention, the lying plane of the leaf 4, when this latter is in the closed position, is outside and parallel to one of the two entry sections of the access opening 2 and, consequently, to allow passage through said opening 2, the sense of rotation of the leaf 4 is on the outside thereof. The hinges 10 of the door 1 are consequently disposed on the outside of the opening 2 and are structured to prevent rotation of the leaf 4 towards the inside of said opening 2.

This layout of the lying plane of the leaf 4 between the jambs 5a, 5b makes it unnecessary to use a subframe to adapt the dimensions of the door 1 to the width of the opening 2, precisely because the door 1 is mounted outside said opening 2, and consequently it is possible to produce doors 1 with even extremely high dimensional tolerances, since to correctly mount the door 1 according to the present invention, the leaf 4 merely requires to extend for a length, in plan, exceeding the distance, also in plan, between the opposite surfaces of the opening 2.

The frame and relative door 1 are therefore extremely easy to mount: after having freely disposed the jambs 5a, 5b on the outer sides of the access opening 2, at a distance essentially equivalent to that of the door leaf 4, and having then connected said jambs 5a, 5b, using the fixing means 7a, 7b, to the respective walls 3a, 3b, to complete mounting of the door 1 the leaf 4 merely requires to be mounted on the hinge 10, provided on one of the jambs 5b.

In particular, in the embodiment in FIG. 1, the fixing means 7a, 7b are constituted by threaded elements, preferably screws, suitably disposed to produce the connection between the jambs 5a, 5b and the relative walls 3a, 3b along coupling surfaces essentially parallel to the lying plane of the leaf 4 between the two jambs 5a, 5b, that is, disposed to engage with the side surfaces of the walls 3a, 3b, on the outside of the access opening 2.

In this way, after fixing the jambs 5a, 5b on the outside surfaces of the opening 2 and positioning the leaf 4 on the hinges 10 there is no need to mount any covering panel to conceal and protect the fixing means 7a, 7b, as they are already essentially protected and concealed by the jambs 5a, 5b and by the leaf 4.

The jambs 5a, 5b may also be surmounted by a traverse (not shown) which, preferably connected after fixing of said jambs 5a, 5b to the walls 3a, 3b, stiffens the frame of the door 1.

Although fixing means 7a, 7b constituted by threaded elements, such as screws or nuts, have been described hereinbefore, it is alternatively possible to connect the jambs 5a, 5b to the outside lateral walls of the access opening 2 with any known mechanical fixing means, such as rivets or bayonet couplings, without however departing from the scope of protection of the present patent right.

With reference to FIG. 2, a variant of the door 1 in FIG. 1 is described, wherein the means for fixing the jambs 5a, 5b to the wall are of a different type to those described above.

Identically to the door in FIG. 1, the door 101 shown in FIG. 2 comprises a frame, fixed to the walls 3a, 3b of a building in correspondence to an access opening 2, mounted on which is a hinged leaf 4, hinged by means of hinges 10 to a first lateral jamb 5b. The hinged leaf 4 extends when closed from the first jamb 5b towards a second lateral jamb 5a, which forms the ledge doorpost for said leaf 4, along a lying plane essentially parallel to and on the outside of one of the entry/exit sections of the access opening 2. The second jamb 5a also comprises a striker part of the lock mechanism 9 of the door, said mechanism being operated by a handle 8 connected to the leaf 4.

In order to allow the lying plane of the leaf 4 to be disposed on the outside, the lateral jambs 5a and 5b are positioned on the side surfaces of the walls 3a, 3b positioned in correspondence to the outside of the access opening 2. The hinges 10, integral with the aforesaid first jamb 5b, are obviously also positioned on the outside of the access opening 2.

In the particular embodiment shown in FIG. 2, the lateral jambs 5a, 5b are not connected directly to the surfaces of the walls 3a, 3b on the outside of the opening 2, but are connected to said walls 3a, 3b by means of “L-shaped” brackets 111a, 111b, each of which is provided on one arm with a plurality of screws 107a, 107b for fixing to the relative wall 3a, 3b, and on the other arm with threaded means 112a, 112b for fixing of the respective jamb 5a, 5b. In this way it is possible to connect the jambs 5a, 5b to the walls 3a, 3b of the opening 2 by means of the screws 107a, 107b that engage inside the opposite inside surfaces of said opening 2, although said jambs 5a, 5b remain positioned at the outside surfaces of the access opening 2.

Moreover, for aesthetic and safety reasons, the jambs 5a, 5b may be structured in order to constitute a support for panels 113a, 113b to cover the inside surfaces of the opening 2, so that the means to fix the frame to the walls 3a, 3b, that is, the brackets 111a, 111b and the screws 107a, 107b and 112a, 112b, are protected and concealed by said panels 113a, 113b and by the leaf 4, and therefore do not form dangerous protrusions from said inside surfaces.

Wall mounting of the door 101 is first performed by fixing, using the screws 112a, 112b, the “L-shaped” brackets 111a, 111b to the relative jambs 5a, 5b and then connecting with the screws 107a, 107b the assembly formed by the brackets 111a, 111b and jambs 5a, 5b to the respective inside surfaces of the access opening 2, if necessary interposing shims (or spacers) 106a, 106b made of synthetic material. Subsequent mounting, on the hinges 10 integral with the upright 5b, of the leaf 4, if necessary positioning further shims 106c, 106d fixed to the jambs 5a, 5b and interposed between these and the leaf 4, completes the assembly of the door 101.

FIGS. 3 to 5 show a particular embodiment of a door 201 according to the present invention, wherein a hinged leaf 204 is connected in rotation, by means of hinges 210, to a frame comprising two lateral jambs 205a, 205b, disposed in correspondence to the outside surfaces of an access opening 2, defined by opposed walls 3a, 3b.

The two outside lateral jambs 205a, 205b define a lying plane for the leaf 204, when this latter is disposed to close the access opening 2, which is parallel to and on the outside of one of the two entry/exit sections of said access opening 2.

The leaf 204 is in particular connected to hinges 110 integral with a first jamb 205b and is also provided with a handle 208 suitable to operate a lock 209 which engages with a striker fixed to a second jamb 205a.

The lateral jambs 205a, 205b are made integral with the outside lateral surfaces of the walls 3a, 3b of the access opening 2 by interposing a secondary frame which comprises, in particular, two vertical supports 211a, 211b integrally constrained with said outside surfaces of the opening 2 by fixing means 207a, 207b, for example of the type formed of threaded elements. The jambs 205a, 205b supporting the leaf 4 are then connected, preferably in a reversible way, to said secondary frame 211a, 211b by means of suitable fastening means 212a, 212b and 213, integral with the jambs 205a, 205b and with the secondary frame 211a, 211b respectively.

The secondary frame 211a, 211b has, in each vertical support, at least a surface portion 213 (see FIGS. 4 and 5) provided with shaped seats 214, and each jamb 205a, 205b has at least a plate 212, integrally constrained with the relative jamb, for example by means of rivets 215, provided with pins 216 with a shaped head. The surface portion 213, with the seats 214, and the plates 212, with the pins 216, constitute, in the particular embodiment of the present invention shown in FIGS. 3 to 5, the aforesaid means to fasten the jambs 205a, 205b to the secondary frame 211a, 211b.

In particular, the seats 214 are shaped so that they have an enlarged portion that allows the head of a pin 216 to be inserted into said seat 214 and a portion with a narrow section that allows the shaft of the pin 216 to slide inside the seat, but prevents the head of the pin from any axial translation (that is, in the direction of the shaft) away from the seat 214. Insertion and subsequent sliding inside the seats 214 of the head of the pins 216, integral with the secondary frame 211a, 211b and with the jambs 205a, 205b respectively, therefore allows said jambs 205a, 205 be to be connected reversibly to the secondary frame 211a, 211b by means of a bayonet-type coupling.

The secondary frame 211a, 211b, as shown in FIG. 3, is in particular connected directly to the outside lateral surfaces of the access opening 2 and the jambs 205a, 205b are also coupled to the secondary frame 211a, 211b by means of surfaces on the outside of the opening 2 and parallel to the lying plane of the leaf 204 between the two jambs 205a, 205b.

Nonetheless, this secondary frame may alternatively be connected to the opposite inside surfaces of the access opening 2 and the coupling surfaces of the secondary frame 211a, 211b and of the jambs 205a, 205b may be disposed in any way without departing from what is claimed in the present patent right, providing the aforesaid lying plane of the leaf 204, between the two jambs 205a, 205b, remains parallel on the outside of said opening 2.

The use of the secondary frame 211a, 211b integrally fixed to the walls 3a, 3b of the access opening 2 and of the jambs 205a, 205b connected non-permanently (that is reversibly) to said secondary frame 211a, 211b allows easy replacement of the jambs 205a, 205b, should the user decide to replace the frame of the door to obtain, for example, a different aesthetic effect.

Moreover, by providing fastening means 212, 213 compatible, that is, of the same type and with the same structure, with jambs 205a, 205b and secondary frames 211a, 211b of different dimensions, forms and/or aesthetic appearances, it is possible to easily obtain varied combinations of jambs and secondary frames, potentially suitable for all needs, without requiring to design and produce costly customized solutions.

It must be observed that, although doors 1; 101; 201 provided with only one hinged leaf 4; 204 have been illustrated hereinbefore, the same technical solution of the present invention, described above, may also be applied to doors provided with more than one hinged leaf, without this requiring the introduction of substantial variations to the technical solutions claimed herein.

According to the present invention, the method to mount a door 1; 101; 201 with at least one hinged leaf 4; 204, in correspondence to an access opening 2 using a frame with at least two lateral jambs 5a, 5b; 205a, 205b which define a lying plane for the leaf 4; 204, when the latter is in its position to close the opening 2, therefore comprises the phase to dispose the lying plane of the leaf 4; 204, when closed, on the outside of the opening 2, parallel to one of the entry/exit sections of said opening 2.

As mentioned above, this allows mounting of the door to be simplified and doors with leaves of dimensions differing even greatly from the dimensions of the access opening to be adapted to said opening.

Preferably, according to the mounting method the jambs 5a, 5b; 205a, 205b are disposed in correspondence to the outside lateral surfaces of the access opening 2 and, more preferably, they are connected directly, or indirectly by means of a secondary frame 211a, 211b, to the outside lateral surfaces of the opening 2.

Alternatively, according to another aspect of the method claimed in the present invention, although remaining disposed in correspondence to the outside lateral surfaces of the opening 2, these jambs 5a, 5b, 205a, 205b may be connected to the inside walls of the opening 2, for example by interposing a bracket 111a, 111b.

1. Frame for doors having one or more hinged leaves, said frame comprising.
a. at least two lateral jambs that define a lying plane for said 5 one or more leaves when these latter are in their closed position; and
b. means for wall fixing said at least two jambs on opposite sides with respect to an access opening produced in the wall of a building, or other dwelling space;
wherein said jambs and said fixing means are structured so 10 lying plane remains parallel to, and on the outside of, an section of said access opening.

2. Frame as claimed in claim 1, wherein said wall fixing means are structured to hold said at least two jambs, after mounting of said frame, on the outside of the sides of side access opening.

3. Frame as claimed in claim 1, wherein said wall fixing means are shaped to connect said jambs and the relative walls of the building, or other dwelling space, according to surfaces parallel to said lying plane.

4. Frame as claimed claim 1, wherein at least one of said lateral jambs supports one or more hinges for at least one of said one or more leaves.

5. Frame as claimed in claim 4, wherein said one or more hinges are disposed in correspondence to the outside lateral surfaces of said access opening.

6. Frame as claimed in claim 1, wherein said least two lateral jambs are connected to each other by at least one upper traverse.

7. Frame as claimed in claim 1, wherein said wall fixing means comprise one or more cylindrical threaded fastening elements, such as screws, bolts or grub screws.

8. Frame as claimed in claim 1, wherein said wall fixing means comprise at least an “L-shaped” bracket interposed between one of said jambs and the fixing wall.

9. Frame as claimed in claim 1, wherein said wall fixing means comprise at least a secondary frame, that can be connected directly to the wall, provided with fastening means for said at least two jambs.

10. Frame as claimed in claim 9, wherein said secondary frame is structured to be connected on the outside of said access opening.

11. Frame as claimed in claim 9, wherein said fastening means are of the type with reversible fastening.

12. Frame as claimed in claim 9, wherein said fastening means for said at least two jambs are of the bayonet type.

13. Frame as claimed in claim 9, wherein said fastening means are produced on a wall of said secondary frame essentially parallel to said lying plane.

14. Method for mounting a door, of the type having one or more hinged leaves, in correspondence to an access opening made in the wall of a building, or other dwelling space, through the use of a frame having two or more jambs that define a lying plane for said one or more leaves when these are disposed to close said opening, wherein said lying plane is disposed on the outside of said access opening, parallel to one of the entry/exit sections thereof.

15. Method as claimed in claim 14, wherein said at least two jambs are disposed at the sides of said access opening.

16. Method as claimed in claim 15, wherein said two jambs are integrally connected to the sides of said access opening by wall fixing means.

17. Method as claimed in claim 15, wherein said two jambs are connected to the relative walls of said building, or other dwelling space, by interposition of a secondary frame.

18. Method as claimed in claim 14, wherein fixing of said at least two lambs is provided by cylindrical threaded fastening elements, such as screws, bolts or grub screws.

19. Door of the type comprising at least one hinged leaf mounted on a frame that can be connected to the wall of a building, or other dwelling space, in correspondence to an access opening by means of at least two lambs that define a lying plane for said leaf, when disposed in the closed position, the door being mounted in conformity with the method as claimed in claim 14.

20. Door of the type comprising at least one hinged leaf mounted on a frame as claimed in claim 1.
